(19) United States
(12) Patent Application Publication
(10) Pub. No.: US 2004/0182276 A1
(43) Pub. Date: Sep. 23, 2004

(54) Seat fixing

(76) Inventor: Lutz Gelbert, Berlin (DE)

Correspondence Address: HOWREY SIMON ARNOLD & WHITE, CITYPOINT, ONE ROPEMAKER STREET, LONDON, EC2Y 9HS, GB

(21) Appl. No.: 10/477,929

(22) PCT Filed: May 22, 2002
(86) PCT No.: PCT/EP02/05609

(30) Foreign Application Priority Data
May 22, 2001 (DE) 10126404.6

(51) Int. Cl. B61D 1/00

(52) U.S. Cl. 105/345

(57) ABSTRACT

The invention relates to a seat fixing, in particular for rail vehicles for personal transport. The aim of the invention is to disclose a seat fixing which may be flexibly applied, independent of the usual height and positional variation of the C-rails, whereby said flexibility permits the number of differing seat holders to be reduced, thus leading to a lower price. Three or more different seat heights (between the range ΔH≅120 mm) should also be capable of being set and should be simple to assemble and various seat shell thicknesses or different types of cushion systems from different manufacturers should also be capable of being positioned in the functionally required seat height. The above is achieved with a seat fixing comprising a horizontal support, fixed on one side to vertical elements and at least one cross-piece, fixed on one side to the horizontal support and on the other side to the vertical elements and/or to the floor in the vicinity of a corner region between the vertical elements and a floor. The horizontal support is fixed to an upper connection point on the vertical elements by means of a side wall adaptation element, in which the side wall adaptation element comprises at least two housing points of the horizontal support and/or the upper connection point, which gives a variable seat height.

The invention pertains to a seat mounting arrangement according to the preamble of claim 1. The invention is suitable for—but not limited to—use in rail vehicles for passenger traffic.

Cantilever seat supports are usually mounted in two C-rails, of which at least the upper rail is arranged in a side wall and the lower rail is arranged in a side wall near the floor or in a floor region near the wall.

Since the positions of the mounting points for the seat support, as well as the regions in which the seats are arranged, frequently differ from rail vehicle to rail vehicle (the seat types, the seat heights and the seat patterns usually differ) the seat supports need to be adapted in order to compensate these differences. Various constructions are known, for example, in order to change the seat height. However, it is very costly to make available a large quantity of different seat supports. EP 0 628 468 B1 describes an arrangement of this type in which the seat is mounted on the vertical sides of a skeleton structure, wherein the skeleton structure comprises a seat rail, a receptacle for a diagonal brace, side wall columns and/or consoles as vertical elements and a floor. The seat mounting arrangement itself comprises a horizontal upper crossbeam and a downwardly extending diagonal brace. The horizontal crossbeam and the diagonal brace are arranged stationarily and rigidly connected to one another. The crossbeam is fixed on vertical elements of the skeleton structure, and the diagonal brace is fixed on vertical elements or in the corner region between vertical elements and the floor. A receptacle for the diagonal brace supports the lower end of this brace. This receptacle is provided with or rigidly connected to a torsionally rigid element. The torsionally rigid element extends over at least the length of the seat arrangement within the skeleton structure. It consists of a hollow chamber profile or a marginal profile of a base plate. The receptacle for the diagonal brace is arranged above and rigidly connected to the hollow chamber profile or the marginal profile. The construction of the seat mounting arrangement needs to be altered and adapted for all skeleton structures, mounting points and/or seat heights which differ from the initial state.

It is an object of the invention to eliminate the described disadvantages of the state of the art and, in particular, to propose a seat mounting arrangement that can be flexibly utilized independently of the usual height and position variations of the connecting points, in particular, the C-rails. This flexibility should reduce the variety of different seat supports such that the price can be lowered. It should be possible to preset and easily realize at least three or more different seat heights (within and adjusting range ÄH≅120 mm). It should also be possible to position seat shells of different thickness and various cushion systems of different manufacturers on seat mounting arrangements of essentially identical construction at the functionally required seat height.

This objective is attained with the seat mounting arrangement according to the characteristics of claims 1 and 2.

Practical embodiments and additional developments of the invention are disclosed in the dependent claims.

The seat mounting arrangement according to the invention comprises at least one horizontal beam that is mounted on vertical elements on one side, as well as at least one crossbeam, one end of which is connected to the horizontal beam by means of a first hinge point and the other end of which is connected to the vertical elements and/or a floor in the vicinity of a corner region between the vertical elements and the floor by means of a second hinge point. The horizontal beam is mounted on an upper connecting point on the vertical elements by means of a side wall adaptation element such that its height can be adjusted, wherein the side wall adaptation element contains at least two receptacles for the horizontal beam and/or the upper connecting point such that different heights of the horizontal beam can be adjusted. Either the first hinge point is realized such that it can be longitudinally displaced and fixed in position on the horizontal beam or the crossbeam is realized such that its length can be varied and fixed. It would also be conceivable to realize the crossbeam in the form of a double crossbeam, i.e., a crossbeam that is divided into two sections, in particular, above and underneath the horizontal beam, to achieve a superior stability against lateral accelerations, if so required.

The advantages of the solution according to the invention can be seen in an unified cantilever support system for passenger seats that can be adjusted to different support or seat heights. It is also advantageous that different seat heights can be realized without having to arrange additional connecting points including the required connecting elements on the vertical elements on which the seat mounting arrangement according to the invention is arranged.

The invention is described in greater detail below with reference to the embodiments that are illustrated in the figures. The figures are not true-to-scale and schematically show:

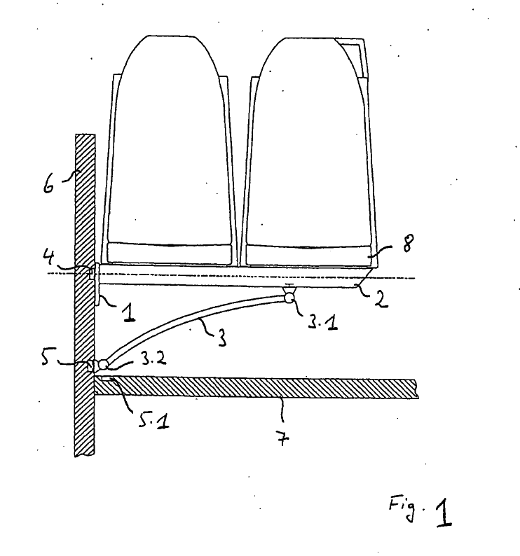

FIG. 1, a cantilever seat mounting arrangement;

FIG. 2, a detail of the seat mounting arrangement with a horizontal beam of adjustable height,

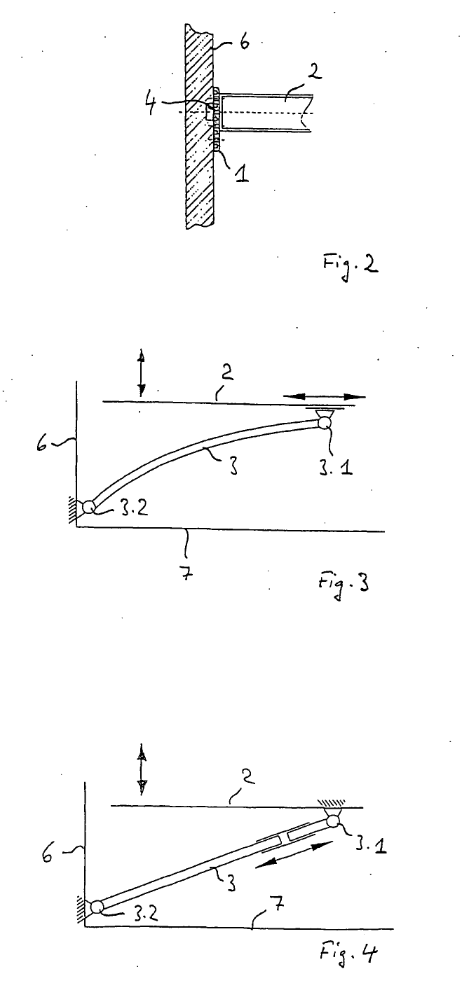

FIG. 3, a detail of the seat mounting arrangement with a curved embodiment of the crossbeam,

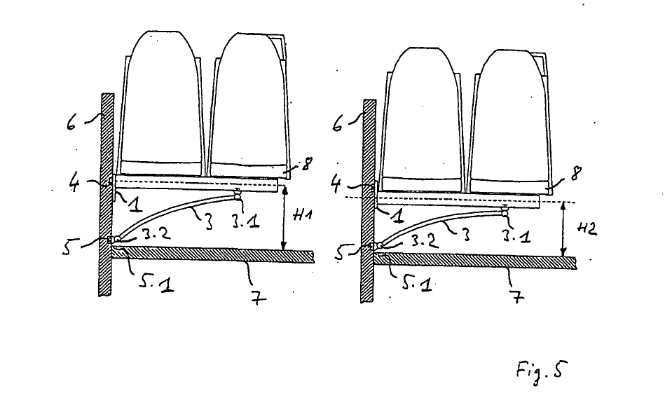

FIG. 4, an alternative to FIG. 3 with a straight embodiment of the crossbeam, and

FIG. 5, an alternative to FIG. 2 with a horizontal beam that can be turned by 180°.

FIG. 1 shows a cantilever seat mounting arrangement that consists of three main elements, namely a side wall adaptation element 1, a horizontal beam 2 and a crossbeam 3 that is realized in the form of a diagonal brace.

The horizontal beam 2 is mounted with its side wall adaptation element 1 on an upper connecting point, in this case on an upper C-rail 4 arranged on a side wall 6 of the vehicle body of a rail vehicle. One end of the crossbeam 3 is mounted on the horizontal beam 2 and the other end of said crossbeam is mounted on a lower connecting point, in particular, on a lower C-rail 5 arranged on the side wall 6 or on a receptacle 5.1 arranged in a region of a floor 7 of the vehicle body which is situated near the wall.

In order to increase the flexibility, it would also be possible to arrange a lower C-rail 5 on the side wall 6 and to arrange a receptacle 5.1 in the region near the wall.

In order to adjust the desired seat height, the side wall adaptation element 1, the horizontal beam 2 and the crossbeam 3 are positively or non-positively connected to one another in a separable fashion. In order to adapt them to the desired support or seat height, they contain a first hinge point 3.1 and a second hinge point 3.2 which, after adjusting the required angular position between the elements of the seat mounting arrangement relative to one another and relative to the side wall, can be positively and/or non-positively fixed and, thus, form a dimensionally stable support system for seat shells 8 arranged on the horizontal beam 2. In this case, the first hinge point 3.1 providing the connection between the crossbeam 3 and the horizontal beam 2 can be displaced on the horizontal beam 2 and fixed in position if the length of the crossbeam 3 is invariable. Alternatively, the position of the hinge point 3.1 is fixed but the length of the crossbeam 3 can be varied and fixed.

In order to adapt the seat mounting arrangement to different wall shapes or wall angles, the connection between the side wall adaptation element 1 and the horizontal beam 2 may be realized in the form of a pivoted connection. A contour or angle compensation can also be achieved with shims, e.g., between the side wall adaptation element 1 and the side wall 6, or with equally acting means.

FIG. 2 shows a detail of the seat mounting arrangement with a horizontal beam of adjustable height, namely the height-adjustable connection between the seat support elements which essentially consist of the horizontal beam 2 and the crossbeam 3, as well as the upper C-rail 4 in the side wall 6, wherein the horizontal beam 2 can be fixed on the C-rail 4 at at least two different heights by means of the side wall adaptation element 1.

For this purpose, the side wall adaptation element 1 contains one to three or even more receptacles for the horizontal beam 2 and/or the C-rail 4. This means that the seat position can be adjusted to several different heights if the receptacles that are arranged above or underneath one another are alternatively utilized.

The arrangement of several simultaneously utilized connecting points at the same height is advantageous, in particular, when utilizing more than one crossbeam, to achieve a more reliable transmission of acceleration forces in the driving direction.

The number of adjustable heights can, if so required, be increased by realizing the side wall adaptation element 1 asymmetrically and such that it can be vertically turned by 180° or by turning the side wall adaptation element 1 about an imaginary horizontal axis that extends perpendicular to the side wall 6.

The horizontal beam 2 serves for mounting various types of seat shells 8 thereon (wherein the cushion thickness of the seat shells may also vary). The vertical forces occurring when the seats are subjected to a load are transmitted into the side wall 6 in the form of a tensile force via the connection with the upper C-rail 4, as well as onto the lower C-rail 4 or the receptacle 5.1 in the floor region near the wall in the form of a compressive force via the crossbeam 3.

The horizontal beam 2 may be realized in one piece (e.g., in the form of a rod-shaped open or closed extruded profile, rolled profile or composite fiber profile) or be composed of several pieces (e.g., in the form of a frame consisting of several sections of said profiles) and may be designed for accommodating a single seat shell or several seat shells that are arranged adjacent and/or behind one another (i.e., such that the rear sides face one another).

The crossbeam 3 serves for supporting the horizontal beam 2. The articulated crossbeam ends at the hinge points 3.1 and 3.2 make it possible for the crossbeam 3 to effectively transmit forces in different angular positions, namely in instances in which the crossbeam has an invariable length and the hinge point 3.1 can be horizontally displaced on the horizontal beam 2 as shown in FIG. 3, as well as in instances in which the hinge point 3.1 is fixed on the horizontal beam 2 (fixed bearing) and the length of the crossbeam 3 can be varied as shown in FIG. 4.

The variable length of the crossbeam 3 is, for example, achieved due to a divided design of the crossbeam, wherein its parts can be longitudinally displaced and then positively connected to one another. In another embodiment of the invention, prefabricated crossbeams of different lengths are simply selected and mounted.

The crossbeam 3 may be realized uncurved, i.e. straight, or curved. The curved variation provides improved legroom.

The side wall adaptation element 1 and the horizontal beam 2 may also be rigidly connected to one another (e.g., by means of welding) if the number of required height adjustments is lower and the horizontal beam 2 can be realized in an axially symmetric fashion as shown in FIG. 5.

In this case, the side wall adaptation element 1 can be mounted at two different heights H1; H2 together with the horizontal beam 2 by turning the side wall adaptation element about an imaginary horizontal axis.

1. A seat mounting arrangement, in particular, for rail vehicles, comprising a horizontal beam (2) that is mounted on vertical elements on one side, as well as at least one crossbeam (3), one end of which is connected to said horizontal beam (2) and the other end of which is connected to said vertical elements and/or to a floor in the vicinity of a corner region between said vertical elements and said floor, characterized in that
said horizontal beam (2) is fixable on an upper connecting point on said vertical elements by means of a side wall adaptation element (1), said side wall adaptation element (1) comprising at least two receptacles for said horizontal beam (2) and/or said upper connecting point causing said horizontal beam (2) to be arranged at different heights,
said end of said crossbeam (3) connected to said horizontal beam (2) is realized in the form of a first hinge point (3.1),
said other end of said crossbeam (3) is realized in the form of a second hinge point (3.2), and
said first hinge point (3.1) is realized to be displaceable along said horizontal beam (2).

2. A seat mounting arrangement, in particular, for rail vehicles, comprising a horizontal beam (2) that is mounted on vertical elements on one side, as well as at least one crossbeam (3), one end of which is connected to said horizontal beam (2) and the other end of which is connected to said vertical elements and/or to a floor in the vicinity of a corner region between said vertical elements and said floor, characterized in that
said horizontal beam (2) is fixable on an upper connecting point on said vertical elements by means of a side wall adaptation element (1), said side wall adaptation element (1) comprising at least two receptacles for said horizontal beam (2) and/or said upper connecting point causing said horizontal beam (2) to be arranged at different heights,
said end of said crossbeam (3) which is connected to said horizontal beam (2) is realized in the form of a first hinge point (3.1),
said other end of said crossbeam (3) is realized in the form of a second hinge point (3.2), and
said crossbeam is of variable and fixable length.

3. The seat mounting arrangement according to claim 1 or 2, characterized in that said side wall adaptation element (1), said horizontal beam (2) and said crossbeam (3) are positively and/or non-positively connected to one another in an unlockable manner for adaptation to a desired seat height.

4. The seat mounting arrangement according to one of claims 1 to 3, characterized in that said upper connecting point is a C-rail (4) or another fixed receptacle element in said wall.

5. The seat mounting arrangement according to one of claims 1 to 4, characterized in that one side of said crossbeam (3) is arranged, in particular, fixed, on said horizontal beam (2) and the other side of said crossbeam is arranged, in particular, fixed, on a lower connecting point, in particular, a C-rail (5) and/or a receptacle (5.1), to said vertical elements, in particular, a side wall (6), and/or to a floor (7) in the vicinity of a corner region between said vertical elements and said floor.

6. The seat mounting arrangement according to one of claims 1 to 5, characterized in that said side wall adaptation element (1) and/or said horizontal beam (2) is realized to be asymmetrical, turnable and fixable in position so as to achieve different seat heights by turning said side wall adaptation element (1) and/or said horizontal beam (2) by a certain angle, in particular, by 180°.

7. The seat mounting arrangement according to one of claims 1 to 6, characterized in that said crossbeam (3) has a first, in particular, fixable, hinge point (3.1) for articulated connection with said horizontal beam (2) as well as a second, in particular, fixable, hinge point (3.2) for articulated connection with said lower connecting point.

8. The seat mounting arrangement according to one of claims 1 to 7, characterized in that the length of said crossbeam (3) is variable and, in particular, fixable, and/or in that said first hinge point (3.1) is arranged on said horizontal beam (2) to be longitudinally displaceable and, in particular, fixable.
